(19) United States
(12) Patent Application Publication
(10) Pub. No.: US 2015/0296022 A1
(43) Pub. Date: Oct. 15, 2015

(54) SYSTEM FOR MEDIATING HETEROGENEOUS DATA EXCHANGE SCHEMES BETWEEN IoT DEVICES

(71) Applicant: SMARTY LAB CO., LTD., Seoul (KR)

(72) Inventors: Soo Dong KIM, Seoul (KR); Hyun Jung LA, Seoul (KR)

(21) Appl. No.: 14/681,501

(22) Filed: Apr. 8, 2015

(30) Foreign Application Priority Data
Apr. 15, 2014 (KR) 10-2014-0045030

(51) Int. Cl. H04L 29/08; H04L 29/06

(52) U.S. Cl. CPC H04L 67/12; H04L 67/1095; H04L 67/42; H04L 67/303

(57) ABSTRACT

Disclosed herein is a system for mediating heterogeneous data exchange schemes between devices in an Internet of things environment, the Internet of things environment including devices having network/Internet ability and a server connected to the devices, including an Internet of things (IoT) application unit provided in a server and connected to devices to interact with the devices so that data is exchanged with the devices or the devices are used; and one or more devices, each having an adapter configured to convert different interfaces for respective devices into a unified interface using an adapter pattern, and provide a unified generic interface, thus unifying data exchange schemes with the IoT application unit.

### BACKGROUND OF THE INVENTION

1. Field of the Invention

The present invention generally relates to a system for mediating heterogeneous data exchange schemes between devices in an Internet of things environment and, more particularly, to a scheme that is capable of effectively utilizing Internet of things (IoT) applications without being influenced by heterogeneity between devices in a method of obtaining context from devices or handling the devices in an Internet of things environment composed of devices having network/Internet ability.

2. Description of the Related Art

Generally, the Internet of Things denotes intelligent technology and service for mutually exchanging information between a human being and a thing and between individual things by connecting all things over the Internet. The Internet of Things is also known by the acronym ‘IoT’.

Such an Internet of things is a further evolved stage of existing wired communication-based Internet or mobile Internet, and is characterized in that devices connected to the Internet process information by mutually exchanging the information with each other without the intervention of human beings. The Internet of things is similar to existing ubiquitous or Machine to Machine (M2M) communication in that things communicate with each other without depending on a human being. However, the Internet of things may be regarded as a stage evolving into interaction with all pieces of information in the real world and the virtual world, as well as things, by extending the concept of M2M to the Internet.

Even at the present time, a large number of types of available Internet of things (IoT) devices have been developed and are used for real life, and it is expected that more diverse types of devices will be developed and used in extended areas in the future.

Technical elements for implementing the Internet of things include sensing technology for acquiring information from visible things and a surrounding environment, wired/wireless communication and network infrastructure technology for supporting things so that the things are connected to the Internet, service interface technology for handling and processing information in conformity with various service areas and types or for merging various types of technologies, and security technology for preventing hacking of components in the Internet of things, such as a large amount of data, or information leakage.

However, such IoT devices have heterogeneity indicating diversity in sensing and actuating functions, programming interfaces, network protocols, data exchange schemes, etc. Among these problems, the problem of heterogeneity in protocol for communication means that schemes for acquiring context values for respective IoT devices are different from each other. There are various schemes ranging from a request/reply scheme that is the most generally used scheme to a polling scheme and a publish/subscribe scheme.

Therefore, when developers desire to develop IoT applications in consideration of such heterogeneity, the IoT applications must be developed in consideration of all the characteristics of respective IoT devices, thus greatly deteriorating development productivity. Further, when existing devices do not operate or improved devices having the same functions are released, and then the replacement of existing devices is required, parts for controlling and managing the corresponding devices in IoT applications must be entirely corrected, thus making it difficult to perform maintenance.

When several conventional technologies for solving the problem are presented, there is a method for solving the heterogeneity problem of hardware using a Hardware Abstraction Layer (HAL) related to HAL (software), http://en.wikipedia.org/wiki/HAL_(software) (Accessed Mar. 4, 2014), and technology proposed by E. Wolfgang, M. Wolfgang, and D. Rainer, “Chapter4. Hardware Abstraction Layer-Introduction and Overview” in Hardware-dependent Software: Principles and Practice, Springer, 2009, pp. 67-94. This method is proposed to solve a problem with the heterogeneity of device Application Programming Interfaces (APIs) provided in C language for various devices that are usable in a single system. First, since a HAL method is focused on a procedural programming technique, a code may be extended by adding a function pointer or performing macro substitution, and a desired function pointer may be dynamically called, but a compile procedure must be necessarily performed, thus making it difficult to perform dynamic macro substitution. Further, since the HAL method does not completely provide object-oriented characteristics such as polymorphism and inheritance, it is difficult to provide the same interface for various types of devices. Second, the problem with heterogeneity mainly stated in the HAL method is limited to the API level between various types of devices. That is, a HAL method provides an HAL API such as device access, interrupt handling, and debugging, thus placing importance on the maintenance of interface consistency with HAL services. Finally, the HAL method is limited in utilizing the advantage of an inheritance relationship because it is implemented in C language that is a procedural language.

Further, as conventional technology, there is a device management protocol proposal-centered method related to a paper by G. Xing, R. Lan-lan, G. Shao-yong, and Q. Xue-song, “The Converged Protocol for Management of Heterogeneous Devices”, In Proceedings of the 6th International Conference on Wireless Communications Networking and Mobile Computing (WICOM 2010), pp 1-5, September 2010, technology entitled “General Middleware Adaptor and Method thereof” disclosed in Korean Patent Application Publication No. 10-2013-0077737 (Date of publication: Jul. 9, 2013), and Korean Patent No. 10-1318881 (Date of publication: Oct. 16, 2013) entitled “Method for Interoperating Between Heterogeneous Devices”). This technology is a method of presenting a standardized protocol to solve the problem with heterogeneity between various types of devices, and is similar to the above-described HAL method in an approach thereof. However, this method is specialized in the Internet of things environment to standardize and define the layer of a protocol and a method which an application must access. However, as the most general method for solving the problem with heterogeneity, the protocol layer and the method have been defined by chiefly taking into consideration the devices constituting the Internet of things environment, but the problem with API heterogeneity rather than the processing heterogeneity of devices, such as a data exchange scheme, is chiefly handled.

Furthermore, as conventional technology, there is a method of solving the problem with heterogeneity between devices by utilizing an SOA approach, which is related to a paper by E. D. Poorter, L. Moerman, and P. Demeester, “Enabling Direct Connectivity between Heterogeneous Objects in the Internet of Things through a Network-Service-Oriented Architecture”, EURASIP Journal on Wireless Communications and Networking, 61 (2011), pp. 1-14, Y. Hong, “A Resource-Oriented Middleware Framework for Heterogeneous Internet of Things”, In Proceedings of 2012 International Conference on Cloud Computing and Service Computing (CSC 2012), pp. 12-16, November 2012., and Korean Patent Application Publication No. 10-2013-0130637 (Date of publication: Dec. 2, 2013) entitled “Method for Integrating Heterogeneous Devices into Web Resources and System Using the Method”. Here, SOA is a paradigm that is capable of requesting and utilizing a required function using only a standardized interface that is desirably defined as Service Oriented Architecture (SOA). When an SOA method is utilized, functions may be used via only an external interface without paying attention to detailed contents of internal implementation, and thus this method is applicable to the solution of the problem with heterogeneity in implementation technology and platform. Such a method enables a function of connecting devices to be implemented as an SOA service and then allows a client application to be used via an interface, thus being applicable to the unification of interfaces and the implementation of logic as a black box. However, in order to utilize an SOA method, a platform or middleware enabling such SOA is essentially required. In this case, in the Internet of things environment, a large number of devices having resource constraints are present, and thus the installation of such middleware is not practical. Further, only a concept in which processing logic in the device is implemented as a black box is defined, and a detailed method for solving the problem with heterogeneity in a data exchange scheme is not presented.

### PRIOR ART DOCUMENTS

### Patent Documents

(Patent Document 1) Korean Patent Application Publication No. 10-2013-0077737 (published on Jul. 9, 2013)

(Patent Document 2) Korean Patent No. 10-1318881 (issued on Oct. 16, 2013)

(Patent Document 3) Korean Patent Application Publication No. 10-2013-0130637(published on Dec. 2, 2013)

### Non-Patent Documents

(Non-patent Document 1) HAL(software), http://en.wikipedia.org/wiki/HAL_(software) (Accessed Mar. 4, 2014)

(Non-patent Document 2) E. Wolfgang, M. Wolfgang, and D. Rainer, “Chapter 4. Hardware Abstraction Layer-Introduction and Overview” in Hardware-dependent Software: Principles and Practice, Springer, 2009, pp. 67-94

(Non-patent Document 3) G. Xing, R. Lan-lan, G. Shao-yong, and Q. Xue-song, “The Converged Protocol for Management of Heterogeneous Devices”, In Proceedings of the 6th International Conference on Wireless Communications Networking and Mobile Computing (WICOM 2010), pp 1-5, September 2010

(Non-patent Document 4) E. D. Poorter, L. Moerman, and P. Demeester, “Enabling Direct Connectivity between Heterogeneous Objects in the Internet of Things through a Network-Service-Oriented Architecture”, EURASIP Journal on Wireless Communications and Networking, 61 (2011), pp. 1-14

(Non-patent Document 5) Y. Hong, “A Resource-Oriented Middleware Framework for Heterogeneous Internet of Things”, In Proceedings of 2012 International Conference on Cloud Computing and Service Computing (CSC 2012), pp. 12-16, November 2012.

### SUMMARY OF THE INVENTION

Accordingly, the present invention has been made keeping in mind the above problems occurring in the prior art, and an object of the present invention is to provide a system for mediating heterogeneous data exchange schemes between devices in an Internet of things environment, which unifies interfaces using an adapter pattern of design patterns and unifies different data exchange schemes for respective Internet of things (IoT) devices via a generic interface required by a server, thus easily collecting data without being influenced by heterogeneity between devices, minimizing development costs for IoT applications, and facilitating maintenance.

Another object of the present invention is to design an adapter pattern-based model for supporting both a polling scheme and a publish/subscribe scheme, and mediate data exchange schemes so that they match each other when data exchange schemes of a device and an IoT application are heterogeneous, thus effectively handling devices by solving the problem with heterogeneity between the data exchange schemes.

A further object of the present invention is to consistently manage devices without being limited by heterogeneity between devices via interaction between a framework for managing the heterogeneity between devices and an adapter, thus enabling an IoT application to effectively use the devices later.

In order to accomplish the above objects, the present invention provides a system for mediating heterogeneous data exchange schemes between devices in an Internet of things environment, the Internet of things environment including devices having network/Internet ability and a server connected to the devices, including an Internet of things (IoT) application unit provided in a server and connected to devices to interact with the devices so that data is exchanged with the devices or the devices are used; and one or more devices, each having an adapter configured to convert different interfaces for respective devices into a unified interface using an adapter pattern, and provide a unified generic interface, thus unifying data exchange schemes with the IoT application unit.

The system may further include a device heterogeneity management framework provided in a server and configured to manage devices interacting with the IoT application unit, the device heterogeneity management framework including a device manager configured to manage devices connected to and used by the IoT application unit by registering, adding, modifying or removing the devices; and a device profile storage unit for storing profiles of devices managed by the device manager.

Further, the generic interface may include a sensing interface and an actuating interface, and may be a set of generic interfaces defined by analyzing commonality and variability of interfaces for methods provided by the devices.

Furthermore, the data exchange scheme may support a polling scheme for returning data from a given device when the IoT application unit requests the data.

Furthermore, the data exchange scheme may support a publish/subscribe scheme for indicating changed values of data when data of a given device is changed.

Here, the publish/subscribe scheme may include a generic Data Transfer Object (DTO) defined as a data type for a device capable of returning changed values of data when data of the device is changed, and configured to be capable of storing data read by a specific interface listener; and a generic listener interface configured to be mapped to a listener of a specific interface of the device and to be capable of controlling a specific device, wherein the publish/subscribe scheme manages listeners by registering or removing the listeners so that the generic listener interface is used in the adapter.

Furthermore, when a data provision scheme of a given device is a publish/subscribe scheme, the device may include a device adapter for polling configured to provide a mediated method so that data is returned using the polling scheme based on the publish/subscribe scheme; and a publish/subscribe device adapter configured to support the publish/subscribe scheme in conformity with characteristics of the device, wherein the device adapter for polling receives changed values of data when data of a targeted device is changed, and stores only a latest data value indicating a recently changed data value, so that, when the IoT application unit requests data, a latest data value among data values received using the publish/subscribe scheme is transferred, thus enabling data to be exchanged using the polling scheme.

Furthermore, when a data provision scheme of a given device is a polling scheme, the device may include a proximity listener configured to periodically read data values from a targeted device; a device adapter for publish/subscribe (PS) configured to provide a mediated method so that data can be returned using a publish/subscribe scheme based on the polling scheme, and to perform a function of registering listeners, which are not present in an existing adapter, and removing unnecessary listeners; and a polling device adapter configured to support the polling scheme in conformity with characteristics of the device, wherein when data values collected by the proximity listener are changed, the data values are transferred to the IoT application unit, thus enabling data to be exchanged using the publish/subscribe scheme.

Accordingly, there is an advantage in that the present invention may unify interfaces using an adapter pattern of design patterns and also unify different data exchange schemes for respective Internet of things (IoT) devices via a generic interface required by a server, thus easily collecting data without being influenced by heterogeneity between devices, minimizing development costs for IoT applications, and facilitating maintenance.

Further, the present invention may design an adapter pattern-based model for supporting both a polling scheme and a publish/subscribe scheme, and mediate data exchange schemes so that they match each other when data exchange schemes of a device and an IoT application are heterogeneous, thus effectively handling devices by solving the problem with heterogeneity between the data exchange schemes.

Furthermore, the present invention may consistently manage devices without being limited by heterogeneity between devices via interaction between a framework for managing the heterogeneity between devices and an adapter, thus enabling an IoT application to effectively use the devices later.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the configuration of a system according to the present invention;

FIG. 2 is a schematic diagram showing an adapter of a device according to the present invention;

FIG. 3 is a diagram illustrating an algorithm for indicating the implementation of an adapter for a device called “Mindstorm” according to the present invention;

FIG. 4 is a schematic diagram showing an adapter design model of a device modified to support a publish/subscribe scheme;

FIG. 5 is a diagram illustrating an algorithm indicating a part in which methods of an adapter of a device for an AR. Drone are implemented;

FIG. 6 is a diagram showing a procedure for collecting gyroscope data from an AR. Drone through a generic listener interface;

FIG. 7 is a diagram showing a process in which a polling scheme is converted into a publish/subscribe scheme to perform mediation in a data exchange scheme;

FIG. 8 is a diagram showing a process in which a publish/subscribe scheme is converted into a polling scheme to perform mediation in a data exchange scheme;

FIG. 9 is a diagram showing the comparison of development of IoT applications of the present invention and conventional technology;

FIG. 10 is a class diagram showing a comparison between the results of IoT applications designed according to the present invention and the conventional technology; and

FIG. 11 is a diagram showing a source code modified to replace an AR. Drone device with a Mindstorm device when the present invention is used.

### DESCRIPTION OF THE PREFERRED EMBODIMENTS

Hereinafter, embodiments of the present invention will be described in detail with reference to the attached drawings.

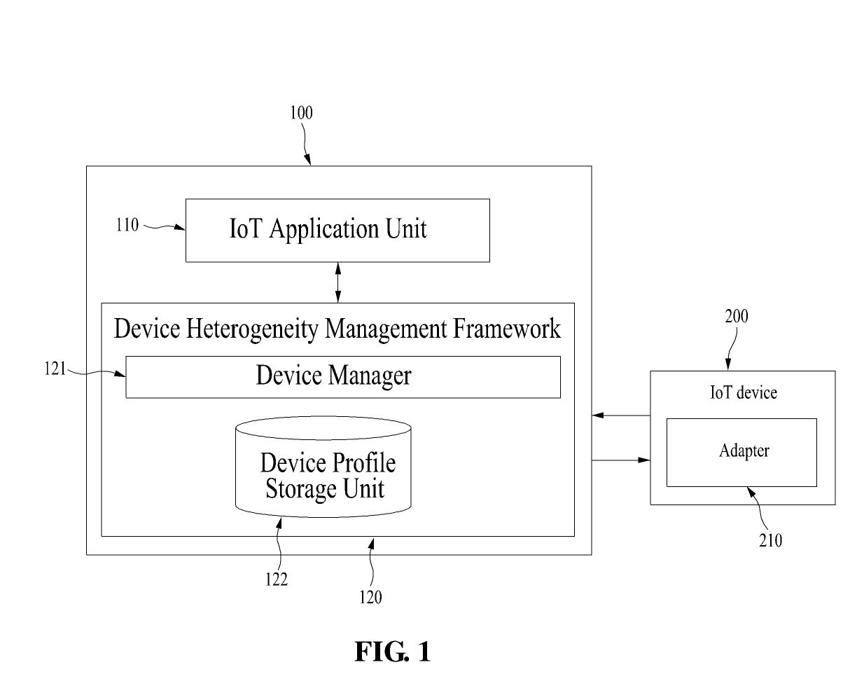

Referring to FIG. 1, a system for mediating heterogeneous data exchange schemes between devices in an Internet of things environment according to the present invention relates to a system for mediating heterogeneous data exchange schemes between Internet of things (IoT) devices 200 having network/Internet abilities in an Internet of things environment including the devices 200 and a server 100 connected to the devices 200.

The present invention may unify different interfaces and data exchange schemes for respective devices 200 using a generic interface and an adapter pattern in the Internet of things environment composed of the devices 200 having network/Internet abilities, thus enabling Internet of things (IoT) applications to effectively handle the devices 200 and collect data without being influenced by heterogeneity between the devices.

As shown in the system configuration diagram of FIG. 1, the server 100 includes an IoT application unit 110 connected to the devices 200 and configured to interact with the devices so that data is exchanged with the devices 200 or the devices 200 are used.

The server 100 may further include a device heterogeneity management framework 120 for managing the devices 200 interacting with the IoT application unit 110.

The device heterogeneity management framework 120 includes a device manager 121 for managing the devices 200 by registering, adding, modifying or removing devices that are connected to and used by the IoT application unit 110; and a profile storage unit 122 for storing the profiles of the devices 200 managed by the device manager 121.

The device manager 121 allows the IoT application unit 110 to effectively use the devices 200, previously registered in the device profile storage unit 122, later. The device profile storage unit 122 stores the profiles of the IoT devices that are registered, added, modified, or removed by the device manager 121.

The device 200 includes an adapter 210 that unifies different interfaces (APIs) for respective devices 200 by converting the different interfaces to provide unified generic interfaces 230, and unifies data exchange schemes with the IoT application unit 110.

Such an adapter 210 functions as a core for solving the problem with heterogeneity between data exchange schemes occurring between the IoT devices 200. The adapter 210 is designed to collect data from the devices 200 using a unified interface, and the IoT application unit 110 may collect data without being influenced by interfaces (APIs) of different adaptees 220 for respective devices 200.

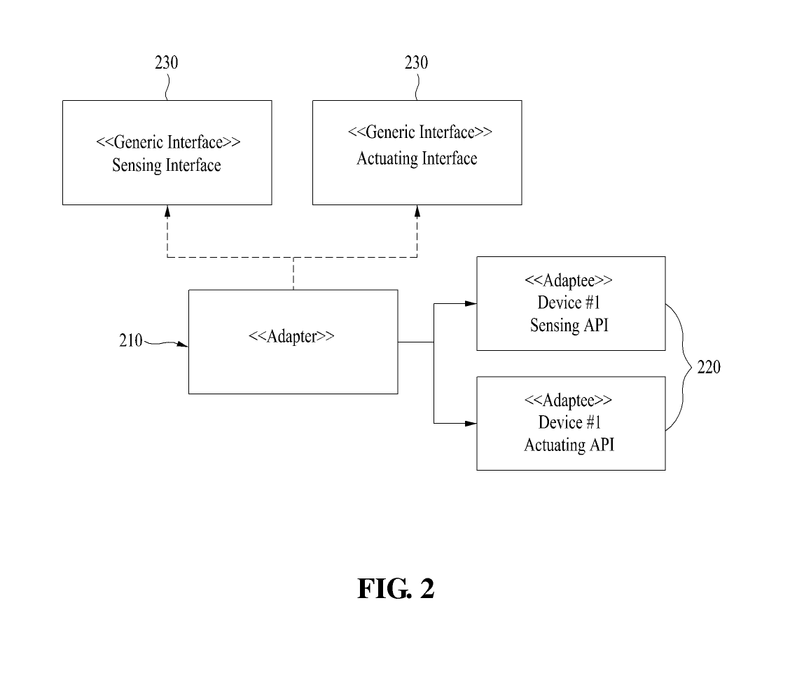

FIG. 2 is a schematic diagram showing an adapter forming one component of the present invention. In the drawing, the adapter is designed using a Gang of Four (GoF) adapter pattern, in which sensing APIs of different adaptees 220 for respective devices 200 are converted into a unified API, so that different data exchange schemes for respective IoT devices 200 are unified through the generic interface required by the server 100.

Here, “GoF” denotes four computer scientists called ‘Gang of Four’ and has initially and specifically presented a design pattern in a software development area via a book entitled “Design Patterns: Elements of Reusable Object-Oriented Software”. The term “adapter pattern” denotes a pattern for converting an interface in a class into another interface expected by a user, and enables classes, which cannot work together due to incompatible interfaces, to work together.

That is, the adapter 210 converts and unifies sensing APIs and actuating APIs of different adaptees 220 for respective devices 200, and then implements unified interfaces as a sensing interface and an actuating interface that correspond to generic interfaces 230. The sensing interface and the actuating interface form a set of generic interfaces defined by analyzing the commonality and variability of APIs provided by various devices 200.

Such an adapter 210 is configured to implement all operations of the generic interfaces 230, and each operation is implemented to call a data collection interface for a specific device 200.

Further, the adapter 210 functions as a medium for enabling different data exchange schemes for respective devices 200 to be unified and used via the generic interfaces 230 required by the device heterogeneity management framework 120.

Furthermore, the devices 200 are managed in a consistent manner without being limited by heterogeneity between the devices 200, via interaction between the device heterogeneity management framework 120 and the adapter 210, thus enabling the IoT application unit 110 to effectively use the devices 200 later.

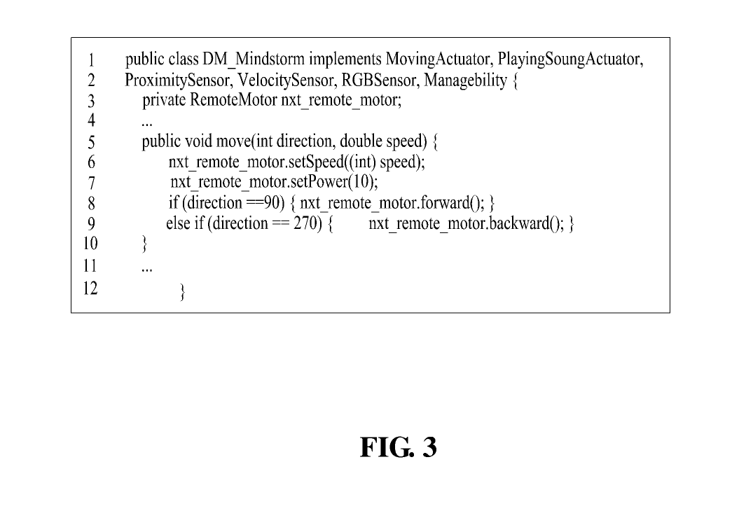

FIG. 3 illustrates an algorithm for indicating the implementation of an adapter for a device called “Mindstorm”. This adapter implements an interface for sensing ability, actuating ability, and management, as well as a moving actuator. Methods configured in the algorithm implement respective functions using a Mindstorm API. A move( ) method called by a client is identical for devices, but the internal logic is implemented in different manners for respective adapters of devices. The internal function of the move( ) is implemented so that the corresponding device can be moved at constant speed by calling methods such as setSpeed( ) and forward( ) provided by a remote motor. In this way, the IoT application unit 110 may call the function of the Mindstorm device using only the generic interfaces 230 provided by the adapter 210.

The data exchange schemes for reading data from an IoT device 200 representatively include a polling scheme for, when the IoT application unit 110 requests data, returning the data from the device 200, and a publish/subscribe scheme for, when the data of the device 200 is changed, providing notification of changed values of the data.

The system for mediating heterogeneous data exchange schemes between devices in an Internet of things environment according to the present invention is preferably designed to support both the polling scheme and the publish/subscribe scheme.

First, an adapter design model, which uses an adapter pattern corresponding to a polling scheme that returns data when the server requests the data, may be utilized and implemented in the present invention without requiring modification.

In contrast, in order to support a publish/subscribe scheme for providing notification of changed values of data when data of the system is changed according to the present invention, an adapter design module, which uses an adapter pattern corresponding to the publish/subscribe scheme, needs to be modified.

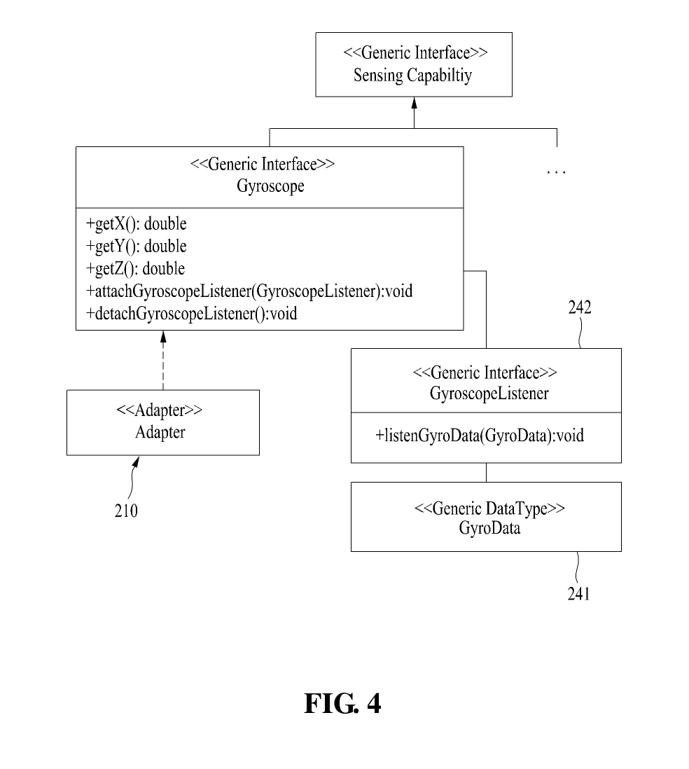

FIG. 4 schematically illustrates the adapter design model of a device modified to support a publish/subscribe scheme. First, in order to extend the function of the adapter 210 of the device 200 so that the adapter 210 supports the publish/subscribe scheme, a generic Data Transfer Object (DTO) and a generic listener interface must be defined, and a generic listener and an API listener must be mapped to each other through such adapters.

Here, DTO typically means an object defined by a user so that various types of data may be stored and moved. In the present invention, a generic DTO 241 is defined as a data type for the device 200 capable of returning changed values when the data of the device 200 is changed, and may store data read by a specific interface listener of the device.

For example, referring to FIG. 4, GyroData denotes a data type for IoT devices 200 capable of returning the values of a gyroscope sensor, and data read by a specific API listener may be stored in the DTO 241, and thus the listener having the stored data as a parameter may read data from all devices 200.

Further, a generic listener interface 242 is provided to be mapped to the listener of a specific interface of a device 200 and to control the specific device 200.

For example, referring to FIG. 4, GyroscopeListener corresponds to the generic listener interface 242, and functions to sense a value transferred via a specific IoT listener.

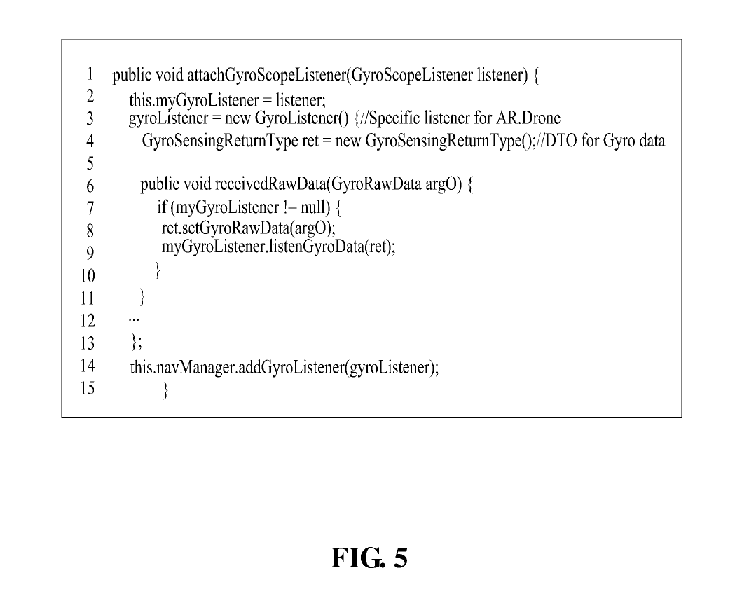

Further, a generic interface 230 must additionally define an operation for registering or removing listeners to use such a listener in the adapter 210. FIG. 5 is a diagram illustrating an algorithm indicating a part in which methods of an adapter of a device for an AR. Drone are implemented.

Referring to FIG. 5, an attachGyroScopeListener method implemented by the adapter of the AR. Drone functions to register GyroScopeListener defined by a user, and listener that is a parameter of the corresponding method is obtained by the user implementing GyroScopeListner that is a generic listener. In lines 3 to 15 of the method, a GyroListener API listener is implemented. Further, ‘ret’ in line 4 is a generic DTO 241 for storing gyroscope-related data. A receivedRawData (GyroRawData arg0) method that is a part for implementing gyroListener stores data read from the device in ret, and transfers the data as a parameter to a listener implemented by the user. Further, the implemented gyroListener is registered in the device as a navManager.addGyroListener(gyroListener) method, and then the corresponding information is read.

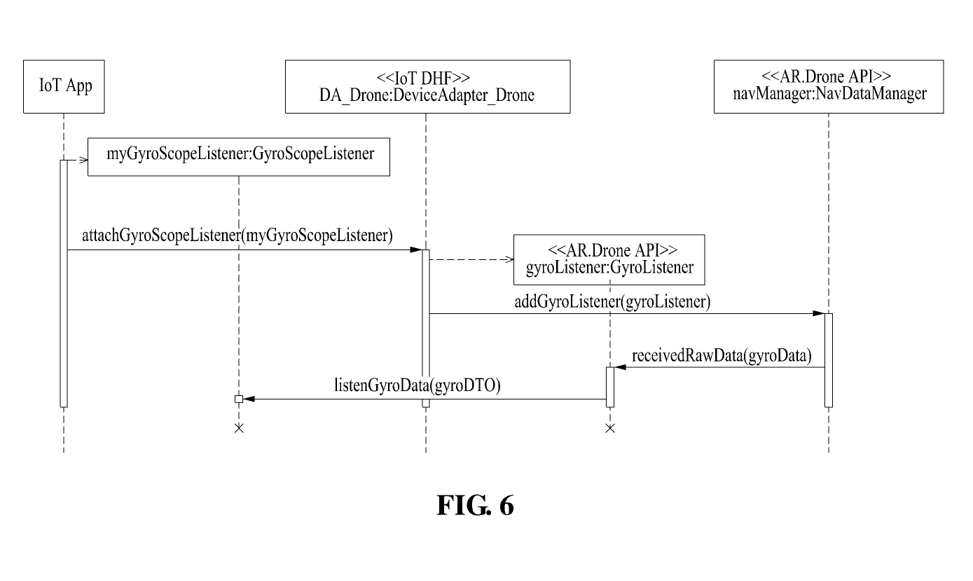

In addition, FIG. 6 is a diagram showing a procedure for collecting gyroscope data from an AR. Drone via a generic listener interface. Here, myGyroScopeListener is obtained by implementing GyroScopeListener that is a generic listener interface, and the corresponding listener is registered via an attachGyroScopeListener(myGyroScopeListener) method of DA_Drone, which is an adapter. Thereafter, whenever gyroscope data is updated, the listenGyroData(gyroDTO) method of the listener is called.

Further, heterogeneity between data exchange schemes may cause a problem because a data collection scheme required by the IoT application unit 110 may not be identical to a data scheme provided by the IoT device 200. That is, the IoT application unit 110 desires to collect data using a polling scheme, but a currently usable IoT device 200 provides data using a publish/subscribe scheme, and vise versa, and thus the data exchange schemes may be mismatched.

In order to prepare for this situation, the present invention may unify the data exchange schemes by providing a method of converting a polling scheme into a publish/subscribe scheme or a method of converting a publish/subscribe scheme into a polling scheme.

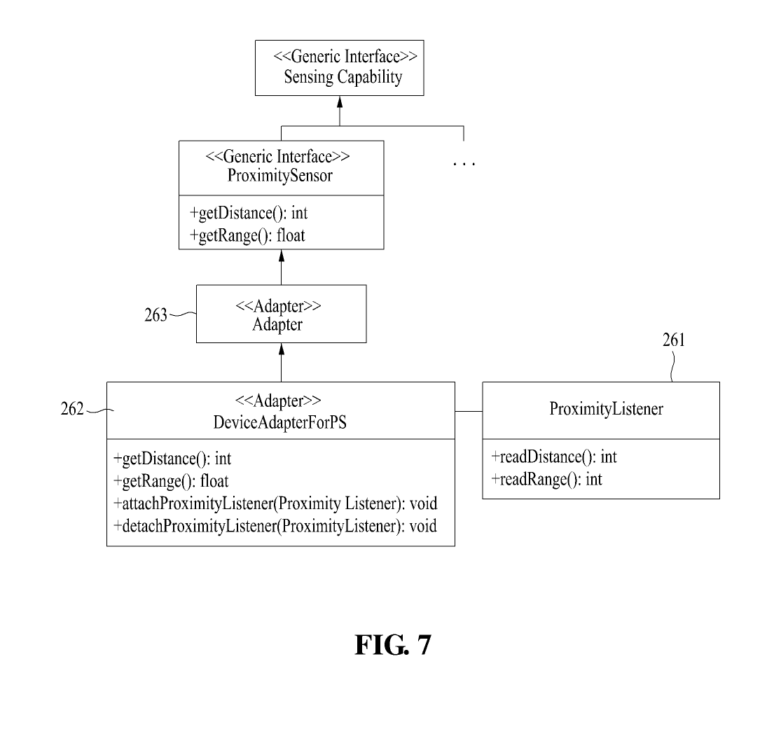

Referring to FIG. 7, in a case where the IoT application unit 110 desires to collect data using a polling scheme, but the data provision scheme of the device 200 is a publish/subscribe scheme, the device 200 includes a device adapter for polling 251 configured to provide a mediated method so that data may be returned using the polling scheme based on the publish/subscribe scheme; and a publish/subscribe device adapter 252 configured to support the publish/subscribe scheme in conformity with the characteristics of the device 200.

In this way, the device adapter for polling 251 receives changed data values when the data of the device 200 that is targeted is changed, and has private variables in which only the latest data value indicating a recently changed data value is stored. Therefore, when a request is received from the IoT application unit 110, the device adapter 251 transfers only the latest value among data values received using the publish/subscribe scheme, and thus may exchange data using the polling scheme.

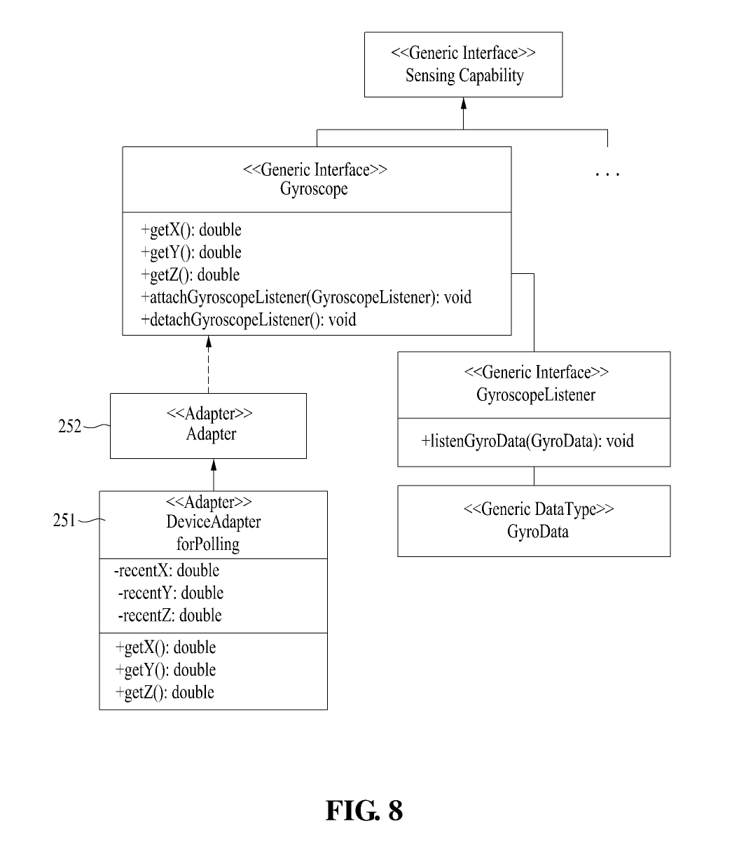

Referring to FIG. 8, in a case where the IoT application unit 110 desires to collect data using a publish/subscribe scheme, but the data provision scheme of the device 200 is a polling scheme, the device 200 includes a proximity listener 261 configured to periodically read data values from a targeted device 200; a device adaptor for PS 262 configured to provide a mediated method so that data can be returned using the publish/subscribe scheme based on the polling scheme, and to register listeners that are not present in an existing adapter and remove unnecessary listeners; and a polling device adapter 263 configured to support the polling scheme in conformity with the characteristics of the device 200.

In this way, when data values periodically read by the proximity listener 261 are changed, the inside of the device is implemented so that a change in data values may be reported to the IoT application unit 110. By means of this structure, when data is periodically connected using the polling scheme and values of data are changed, the changed values are transferred and may be exchanged using the publish/subscribe scheme.

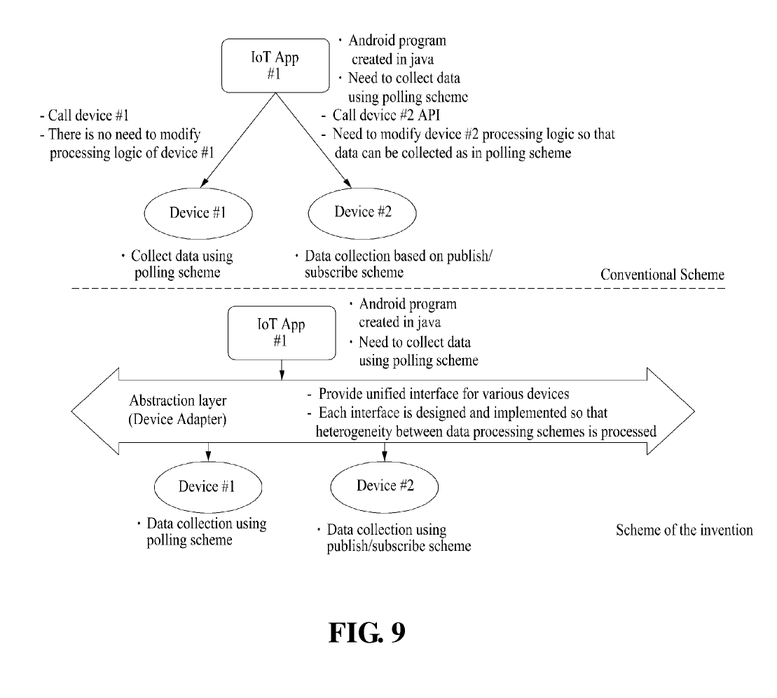

Meanwhile, FIG. 9 is a diagram showing the comparison of development of IoT applications designed according to the present invention and conventional technology. In the conventional technology, respective IoT devices provide different interfaces, and collect data using different schemes. For example, source code of IoT App #1 must be created so that data may be collected using a polling scheme via an interface provided by device #1, data may be collected using a publish/subscribe scheme via an interface provided by device #2, and then data may be returned as in the case of the polling scheme.

However, in the scheme of the present invention, a device adapter functioning as an abstraction layer collects data via interfaces of device #1 and device #2, and returns data in conformity with a scheme desired by IoT App #1, and thus IoT App #1 may process IoT devices using a desired scheme by calling only a common interface exposed by the device adapter.

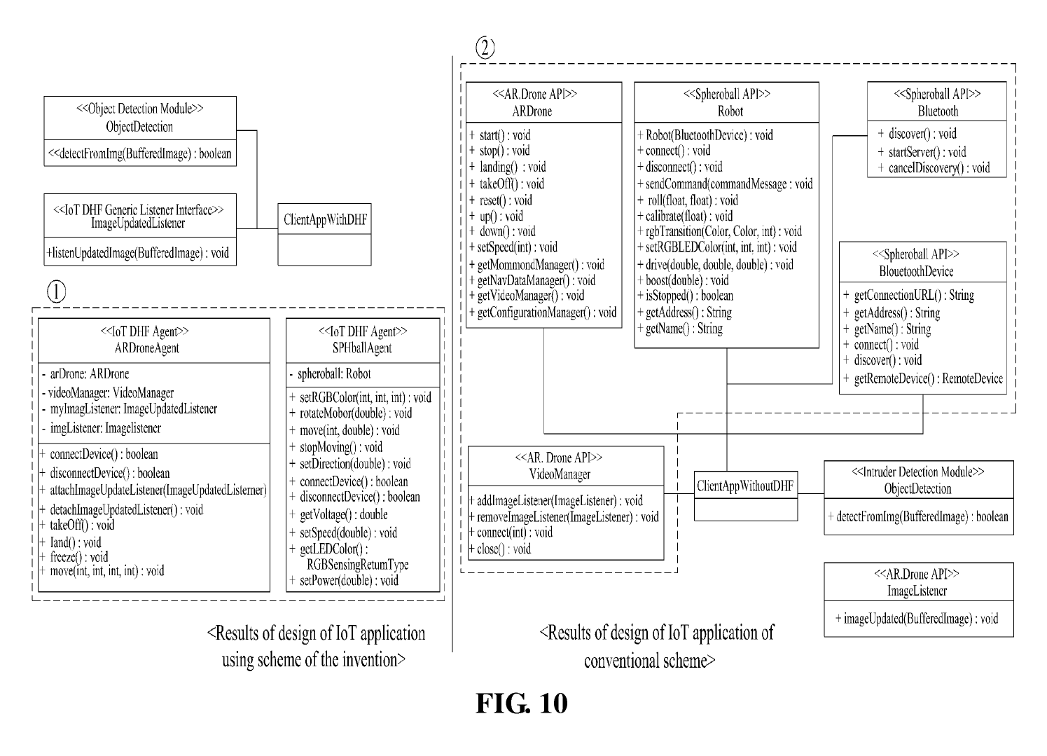

Further, FIG. 10 is a class diagram showing a comparison between the results of IoT applications desired according to the present invention and conventional technology. When the present invention is used, part \textcircled{1} is provided by the device adapter, and thus there is only a need to call a suitable method of the adapter belonging to \textcircled{1} via ClientAppWithDHF without needing to implement part \textcircled{1}. Otherwise, five classes corresponding to part \textcircled{2} for controlling the device must be directly designed and implemented, and ClientAppWithoutDHF for calling the classes must also be implemented to use a suitable class, thus increasing a burden of development.

The following Table 1 indicates the results of analysis of differences in development costs. As shown in Table 1, when the present invention is used, the development costs of IoT applications may be further decreased and minimized.

TABLE 1

| Client | Number of | Line of Codes | | |
|---|---|---|---|---|
| application | Classes | Connection | Sensing | Actuating |
| With | 1 (ClientAppwithDHF) | 2 | 9 | 4 |
| framework | | | | |
| Without | 5 + 1 | 11 | 10 | 6 |
| framework | (ClientAppWithoutDHF) | | | |

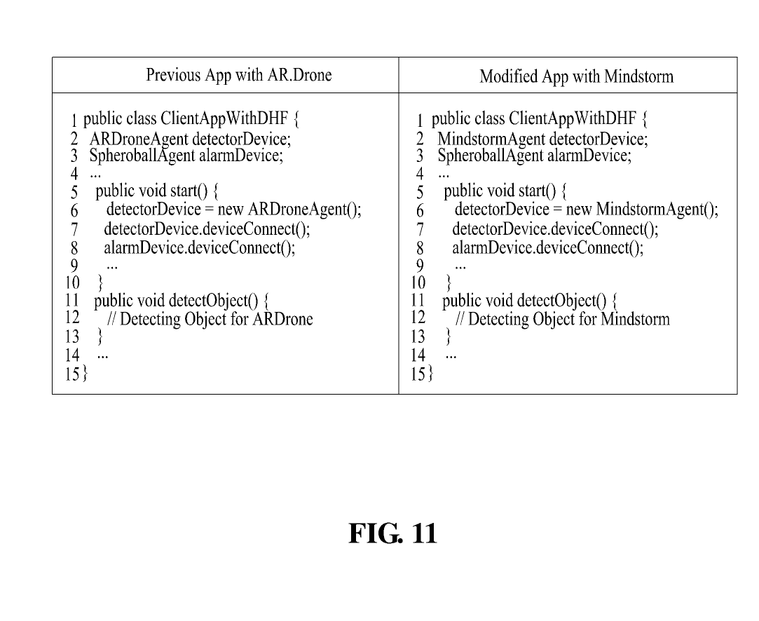

FIG. 11 is a diagram showing a source code modified to replace an AR. Drone device with a Mindstorm device when the present invention is used. A left source code is a source code using the AR. Drone, and needs to be changed to a right source code of FIG. 11 in order to be changed to a source code for use in the Mindstorm device. Spheroball in line 3, functioning as an alarm, does not need to be changed, and only lines 2, 6, 11˜13 corresponding to the source code of the device functioning to sense things need to be changed. A detectObject method in line 11 needs to be modified because different logic structures for sensing things may be used for respective devices. However, portions corresponding to left/right lines 7 of FIG. 11 are implemented as generic interfaces, and thus do not need to be changed.

Consequently, the system for mediating heterogeneous data exchange schemes between devices in an Internet of things environment according to the present invention may unify interfaces using an adapter pattern of design patterns and also unify different data exchange schemes for respective Internet of things (IoT) devices via a generic interface required by a server, thus easily collecting data without being influenced by heterogeneity between devices, minimizing development costs for IoT applications, and facilitating maintenance. Further, the present invention may design an adapter pattern-based model for supporting both a polling scheme and a publish/subscribe scheme, and mediate data exchange schemes so that they match each other when data exchange schemes of a device and an IoT application are heterogeneous, thus effectively handling devices by solving the problem with heterogeneity between the data exchange schemes. Furthermore, the present invention may consistently manage devices without being limited by heterogeneity between devices via interaction between a framework for managing the heterogeneity between devices and an adapter, thus enabling an IoT application to effectively use the devices later.

As described above, although the present invention has been described in detail with reference to preferred embodiments of the present invention, the scope of the present invention is not limited to specific embodiments, and should be interpreted by the accompanying claims. Further, it is apparent that those skilled in the art may practice various modifications and applications, without departing from the scope and spirit of the present invention.

What is claimed is:

1. A system for mediating heterogeneous data exchange schemes between devices in an Internet of things environment, the Internet of things environment including devices having network/Internet ability and a server connected to the devices, comprising:
an Internet of things (IoT) application unit provided in a server and connected to devices to interact with the devices so that data is exchanged with the devices or the devices are used; and
one or more devices, each having an adapter configured to convert different interfaces for respective devices into a unified interface using an adapter pattern, and provide a unified generic interface, thus unifying data exchange schemes with the IoT application unit,
wherein the generic interface includes a sensing interface and an actuating interface, and is a set of generic interfaces defined by analyzing commonality and variability of interfaces for methods provided by the devices.

2. A system for mediating heterogeneous data exchange schemes between devices in an Internet of things environment, the Internet of things environment including devices having network/Internet ability and a server connected to the devices, comprising:
an Internet of things (IoT) application unit provided in a server and connected to devices to interact with the devices so that data is exchanged with the devices or the devices are used; and
one or more devices, each having an adapter configured to convert different interfaces for respective devices into a unified interface using an adapter pattern, and provide a unified generic interface, thus unifying data exchange schemes with the IoT application unit,
wherein the data exchange scheme supports a polling scheme for returning data from a given device when the IoT application unit requests the data.

3. A system for mediating heterogeneous data exchange schemes between devices in an Internet of things environment, the Internet of things environment including devices having network/Internet ability and a server connected to the devices, comprising:
an Internet of things (IoT) application unit provided in a server and connected to devices to interact with the devices so that data is exchanged with the devices or the devices are used; and
one or more devices, each having an adapter configured to convert different interfaces for respective devices into a unified interface using an adapter pattern, and provide a unified generic interface, thus unifying data exchange schemes with the IoT application unit,
wherein the data exchange scheme supports a publish/subscribe scheme for indicating changed values of data when data of a given device is changed.

4. The system of claim 3, wherein the publish/subscribe scheme comprises:
a generic Data Transfer Object (DTO) defined as a data type for a device capable of returning changed values of data when data of the device is changed, and configured to be capable of storing data read by a specific interface listener; and
a generic listener interface configured to be mapped to a listener of a specific interface of the device and to be capable of controlling a specific device,
wherein the publish/subscribe scheme manages listeners by registering or removing the listeners so that the generic listener interface is used in the adapter.

5. The system of claim 2, wherein, when a data provision scheme of a given device is a publish/subscribe scheme, the device comprises:
a device adapter for polling configured to provide a mediated method so that data is returned using the polling scheme based on the publish/subscribe scheme; and
a publish/subscribe device adapter configured to support the publish/subscribe scheme in conformity with characteristics of the device,
wherein the device adapter for polling receives changed values of data when data of a targeted device is changed, and stores only a latest data value indicating a recently changed data value, so that, when the IoT application unit requests data, a latest data value among data values received using the publish/subscribe scheme is transferred, thus enabling data to be exchanged using the polling scheme.

6. The system of claim 3, wherein, when a data provision scheme of a given device is a polling scheme, the device comprises:
a proximity listener configured to periodically read data values from a targeted device;
a device adapter for publish/subscribe (PS) configured to provide a mediated method so that data can be returned using a publish/subscribe scheme based on the polling scheme, and to perform a function of registering listeners, which are not present in an existing adapter, and removing unnecessary listeners; and
a polling device adapter configured to support the polling scheme in conformity with characteristics of the device,
wherein, when data values collected by the proximity listener are changed, the data values are transferred to the IoT application unit, thus enabling data to be exchanged using the publish/subscribe scheme.

7. The system of claim 1, further comprising a device heterogeneity management framework provided in a server and configured to manage devices interacting with the IoT application unit, the device heterogeneity management framework comprising:
a device manager configured to manage devices connected to and used by the IoT application unit by registering, adding, modifying or removing the devices; and
a device profile storage unit for storing profiles of devices managed by the device manager.

8. The system of claim 4, wherein, when a data provision scheme of a given device is a polling scheme, the device comprises:
a proximity listener configured to periodically read data values from a targeted device;
a device adapter for publish/subscribe (PS) configured to provide a mediated method so that data can be returned using a publish/subscribe scheme based on the polling scheme, and to perform a function of registering listeners, which are not present in an existing adapter, and removing unnecessary listeners; and
a polling device adapter configured to support the polling scheme in conformity with characteristics of the device,
wherein, when data values collected by the proximity listener are changed, the data values are transferred to the IoT application unit, thus enabling data to be exchanged using the publish/subscribe scheme.

9. The system of claim 2, further comprising a device heterogeneity management framework provided in a server and configured to manage devices interacting with the IoT application unit, the device heterogeneity management framework comprising:
a device manager configured to manage devices connected to and used by the IoT application unit by registering, adding, modifying or removing the devices; and
a device profile storage unit for storing profiles of devices managed by the device manager.

10. The system of claim 3, further comprising a device heterogeneity management framework provided in a server and configured to manage devices interacting with the IoT application unit, the device heterogeneity management framework comprising:
a device manager configured to manage devices connected to and used by the IoT application unit by registering, adding, modifying or removing the devices; and
a device profile storage unit for storing profiles of devices managed by the device manager.
